(19) United States
(12) Patent Application Publication
(10) Pub. No.: US 2024/0320835 A1
(43) Pub. Date: Sep. 26, 2024

(54) Method for assessing carbon capture of an area of interest

(71) Applicant: ATOS France, BEZONS (FR)

(72) Inventor: Andrew WALLACE, Kelsall (GB)

(73) Assignee: ATOS France, BEZONS (FR)

(21) Appl. No.: 18/586,690

(22) Filed: Feb. 26, 2024

(30) Foreign Application Priority Data
Mar. 21, 2023 (EP) 23305383.4

(51) Int. Cl. G06T 7/11; G06V 20/10

(52) U.S. Cl. CPC G06T 7/11; G06V 20/176; G06T 2207/10024; G06T 2207/10036; G06T 2207/30188

(57) ABSTRACT

The invention relates to a computer-implemented method (20) for assessing carbon capture in an area of interest, the method comprising:
implementing (22) at least one image analysis algorithm on at least one top-down image of at least part of the area of interest, to determine environmental data representative of at least one primary producer and/or at least one biotope of the area of interest;
based on the determined environmental data, computing (24) a carbon capture indicator representative of an estimated carbon capture potential of the area of interest.

### FIELD OF THE INVENTION

The present invention relates to a method for assessing carbon capture in an area of interest.

The invention further relates to a computer program, and to a device configured to perform said method.

The invention applies to the field of remote monitoring, and more specifically to the remote assessment of carbon capture of an area of interest.

### BACKGROUND

According to the 2021 Intergovernmental Panel on Climate Change (IPCC) report, it is required to limit global warming to 1.5° C. above pre-industrial levels in order to prevent the most dangerous and irreversible aspects of climate change.

In this context, atmospheric carbon dioxide, which is known to be a major contributor to greenhouse effect, has seen its levels reach 421 ppm (parts per million) in 2022, an increase, according to the National Oceanic and Atmospheric Administration (NOAA), of 50% over pre-industrial levels.

Oceans cover 71% of the world's surface area, and research shows that marine primary producers have enormous potential as a source of carbon capture.

Today, to measure the carbon capture potential of a given area of coastal or marine environment, it is required to perform on-site observations and measurements to obtain relevant data, and to determine the carbon capture of said area based on the obtained data.

However, this method is not entirely satisfactory.

Indeed, the obtained data are limited to the areas that can actually be reached by a human expert.

Furthermore, such method is heavily based on human expertise, so that it lacks reliability, consistency and repeatability.

A purpose of the present invention is to overcome at least one of these drawbacks.

Another purpose of the invention is to provide a reliable, consistent and repeatable way to remotely measure the carbon capture potential of an area, especially an area of coastal or marine environment.

Another purpose of the invention is to provide a method that does not rely as much on human expertise to perform such measurement.

### SUMMARY OF THE INVENTION

To this end, the present invention is a method of the aforementioned type, comprising:
implementing at least one image analysis algorithm on at least one top-down image of at least part of the area of interest, to determine environmental data representative of at least one primary producer and/or at least one biotope of the area of interest;
based on the determined environmental data, computing a carbon capture indicator representative of an estimated carbon capture potential of the area of interest.

Indeed, by determining the carbon capture potential of the area of interest based on top-down images of said area of interest, remote monitoring is achieved. In other words, the need to perform on-site measurement, especially in hard-to-reach and/or remote areas such as areas of coastal or marine environment, is overcome.

Moreover, the outputs provided by the image analysis algorithm are repeatable and quantifiable. Consequently, the invention provides a reliable, consistent and repeatable way to remotely measure the carbon capture potential of an area of interest.

According to other advantageous aspects of the invention, the method includes one or several of the following features, taken alone or in any technically possible combination:
the computed carbon capture indicator is a net primary productivity of the area of interest;
the method further comprises calculating the carbon capture potential of the area of interest based on the net primary productivity and a size of the area of interest;
the determined environmental data include at least one primary producer of the area of interest, and wherein computing the carbon capture indicator includes associating each primary producer to a corresponding expected net primary productivity;
the carbon capture indicator is further computed based on habitat data associated with the area of interest and representative of climatic features, pedological features and/or sediment characteristics, geological features, hydrographic features and/or topographic features of the area of interest;
the step of implementing at least one image analysis algorithm includes computing, based on each top-down image, a normalized difference vegetation index and a normalized difference water index, the environmental data being determined based on the computed normalized difference vegetation index and normalized difference water index;
the environmental data is further determined based on a series of top-down images of the area of interest acquired at different acquisition dates;
the method further includes retrieving on-site measurement data representative of at least one physical and/or chemical property of the area of interest, the carbon capture indicator being further computed based on the retrieved on-site measurement data;
the step of implementing at least one image analysis algorithm includes detecting the presence of at least one predetermined human-made structure in the area of interest, the carbon capture indicator being further computed based on each detected human-made structure;
the method further includes predicting an evolution of the carbon capture indicator over time based on the determined environmental data;
the evolution of the carbon capture indicator over time is further predicted based on each detected human-made structure;
at least one of the determined environmental data and the computed carbon capture indicator is associated with a date of acquisition of each corresponding top-down image, the method further including monitoring an evolution of the environmental data and/or the carbon capture indicator over time, and outputting an alert signal if a corresponding variation over time is outside a predetermined range;
the method further comprises:
implementing at least one image analysis algorithm on at least one top-down image of at least one neighbouring area adjacent to the area of interest, to determine environmental data representative of at least one primary producer and/or at least one biotope of each neighbouring area;
for each neighbouring area, computing a carbon capture indicator representative of an estimated carbon capture potential of said neighbouring area, based on the determined environmental data of said neighbouring area and on the computed carbon capture indicator of the area of interest.

According to another aspect of the same invention, it is proposed a computer program comprising instructions, which when executed by a computer, cause the computer to carry out the steps of the method as defined above.

The computer program may be in any programming language such as C, C++, JAVA, Python, R, a GIS (Geographical Information System) programming language, etc.

The computer program may be in machine language.

The computer program may be stored, in a non-transient memory, such as a USB stick, a flash memory, a hard-disc, a processor, a programmable electronic chop, etc.

The computer program may be stored in a computerized device such as a computer, a smartphone, a tablet, a server, etc.

The invention also relates to a remote monitoring system for assessing carbon capture in an area of interest, the remote monitoring system including a processing unit configured to:
implement at least one image analysis algorithm on at least one top-down image of at least part of the area of interest, to determine environmental data representative of at least one primary producer and/or at least one biotope of the area of interest;
based on the determined environmental data, compute a carbon capture indicator representative of an estimated carbon capture potential of the area of interest.

The system may be a personal device such as a computer, a smartphone, a tablet, a smartwatch, any wearable electronic device, etc.

The system according to the invention may execute one or several applications to carry out the method according to the invention.

The system according to the invention may be loaded with, and configured to execute, the computer program according to the invention.

### BRIEF DESCRIPTION OF THE DRAWINGS

Other advantages and characteristics will become apparent on examination of the detailed description of an embodiment which is in no way limitative, and the attached figures, where:

FIG. 1 is a schematic representation of a remote monitoring system according to the invention; and

FIG. 2 is a flowchart of a method for assessing carbon capture performed by the remote monitoring system of FIG. 1.

It is well understood that the embodiments that will be described below are in no way limitative. In particular, it is possible to imagine variants of the invention comprising only a selection of the characteristics described hereinafter, in isolation from the other characteristics described, if this selection of characteristics is sufficient to confer a technical advantage or to differentiate the invention with respect to the state of the prior art. Such a selection comprises at least one, preferably functional, characteristic without structural details, or with only a part of the structural details if this part alone is sufficient to confer a technical advantage or to differentiate the invention with respect to the prior art.

In the figures, elements common to several figures retain the same reference.

### DETAILED DESCRIPTION

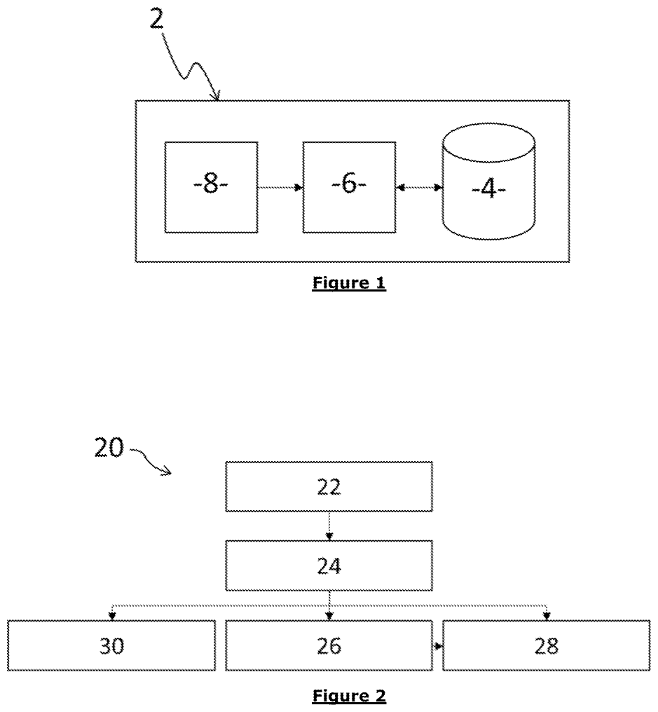

A remote monitoring system 2 according to the invention is show on FIG. 1.

The remote monitoring system 2 is configured to remotely assess carbon capture in one or several area(s) of interest, based on remote measurements, especially top-down images of said area(s) of interest.

The remote monitoring system 2 includes a knowledge database 4 and a processing unit 6 connected to said knowledge database 4.

The remote monitoring system 2 further includes a user interface 8 connected to the processing unit 6, to allow a user to input instructions relating to each area of interest for which an assessment of the carbon capture is needed.

### Knowledge Database 4

The knowledge database 4 is configured to store data linking primary producers and/or biotopes to carbon capture.

By “primary producers”, it is meant, in the context of the present invention, organisms that produce complex organic compounds using carbon in a simple form (e.g., carbon dioxide), for instance using photosynthesis. Such organisms generally form the first link in the local food chain.

By “biotope”, it is meant, in the context of the present invention, a combination of a habitat and of key organisms (such as primary producers) that are endemic to said habitat.

By “habitat”, it is meant, in the context of the present invention, an environment where organisms might live.

### Primary Producer Data

For example, the knowledge database 4 is configured to store, for each biotope, primary producer data representative of the expected primary producers of said biotope, i.e., the primary producers that are most likely to be found in said biotope.

As an example, in the case of areas of marine and/or coastal environment, the primary producers that are most likely to be found include mangrove, saltmarsh, seagrass and/or macroalgae.

### Primary Productivity Data

The knowledge database 4 may also be configured to store, for each primary producer, primary productivity data representative of the expected net primary productivity for said primary producer.

By “net primary productivity”, it is meant, in the context of the present invention, the amount of carbon retained in an area, which generally corresponds to an increase in biomass over time. The net primary productivity is equal to the difference between the amount of carbon produced through photosynthesis and the amount of carbon that is lost to respiration.

Such primary productivity data may be automatically extracted from relevant scientific literature on a regular basis.

### Carbon Capture Data

The knowledge database 4 may also be configured to store, for each primary producer, carbon capture data for converting the associated net primary productivity to a corresponding carbon capture.

By “carbon capture”, it is meant, in the context of the invention, the mass of carbon sequestrated in the habitat, per surface unit and time unit. Carbon capture is generally expressed in grams of carbon per square metre per year.

Such carbon capture data may be automatically extracted from relevant scientific literature on a regular basis.

### On-Site Measurement Data

The knowledge database 4 may be further configured to store on-site measurement data representative of at least one physical and/or chemical property of the area of interest.

The on-site measurement data may include environmental DNA (eDNA), or other data collected using probes such as camera traps, monitoring buoys and the like.

Preferably, the one-site measurement data are georeferenced, so that they are unambiguously associated with a respective location.

### Habitat Data

Furthermore, the knowledge database 4 may further be configured to store habitat data associated with observed areas.

Preferably, for each observed area, the habitat data include topological data representative of topological features of the observed area.

For instance, the topological data comprise point cloud data including a plurality of points, each associated with corresponding X, Y & Z coordinates in a predetermined coordinate system that are representative of a respective position in the observed area.

Alternatively, or in addition, for a given observed area, the habitat data are representative of climatic features, pedological features and/or sediment characteristics, geological features, hydrographic features and/or topographic features of the said observed area.

The habitat data may be determined based on high-definition photogrammetry and/or derived from lidar (for “Light Detection And Ranging”) acquisitions, performed using a drone or a piloted aircraft, for example.

Preferably, for lidar acquisitions, a laser having a central wavelength of 532 nm is used, in order to maximise water penetration in marine and/or coastal environment, thereby allowing 3D bathymetric image creation to approximately 10 m depth.

### Top-Down Images

The knowledge database 4 is also configured to store top-down images of each area of interest.

For instance, such top-down images have been previously acquired from an aircraft flying over the area of interest.

Alternatively, or in addition, the top-down images may be satellite images, such as satellite images extracted from Landsat, Sentinel, Copernicus and/or PLANET satellite data.

For instance, said satellite images are multi-band satellite images such as images in band 3 (green, e.g., between 0.53 μm and 0.59 μm), band 4 (red, e.g., between 0.64 μm and 0.67 μm), band 5 (near infrared, or NIR, e.g., between 0.85 μm and 0.88 μm) and/or band 6 (short wave infrared, or SWIR, e.g., between 1.57 μm and 1.65 μm and/or between 2.11 μm and 2.29 μm).

### Processing Unit 6

The processing unit 6 is a hardware-based unit, such as a processor, an electronic chip, a calculator, a smartphone, a computer, a server and the like. Alternatively, or in addition, the processing unit 6 is a software-based unit, such as an application, a computer program, a virtual machine and the like.

The processing unit 6 is configured to receive, from the user interface 8, the instructions originating from the user and relating to the area of interest for which an assessment of the carbon capture is required.

For instance, to input the aforementioned instructions, the user selects a geographic zone on a displayed map, said selected geographic zone forming the area of interest.

The processing unit 6 is further configured to retrieve, from the knowledge database 4, at least one top-down image of at least part of the area of interest.

Moreover, the processing unit 6 is configured to perform an assessment method 20 (FIG. 2) to process each retrieved top-down image in order to output a carbon capture indicator representative of an estimated carbon capture potential of the area of interest.

The assessment method 20 comprises an image analysis step 22 and a carbon capture estimation step 24.

Optionally, the assessment method 20 further comprises a forecasting step 26, a monitoring step 28 and/or an influence determination step 30.

### Image Analysis Step 22

The processing unit 6 is configured to implement, during the image analysis step 22, at least one image analysis algorithm on each retrieved top-down image, in order to determine environmental data associated with the area of interest. The determined environmental data are representative of at least one biotope and/or at least one primary producer of the area of interest.

For instance, the determined environmental data include at least one biotope of the area of interest and/or at least one primary producer of the area of interest.

Advantageously, for each biotope, respectively for each primary producer, the processing unit 6 is configured to determine the surface, within the area of interest, that is occupied by said biotope, respectively for said primary producer.

For instance, the processing unit 6 is configured to perform image recognition on the retrieved top-down image to determine the environmental data associated with the area of interest. In this case, the processing unit 6 is configured to associate predetermined shapes (and/or predetermined combinations of shapes and colours) in the retrieved top-down image with at least one primary producer and/or with at least one biotope.

Alternatively, or in addition, the processing unit 6 is configured to extract colour features from one or more colour channel(s) of the top-down image and to determine the environmental data based on the extracted colour features.

For instance, such colour features include, for each top-down image, a normalized difference vegetation index (NDVI) and/or a normalized difference water index (NDWI).

A general formula for the computation of the normalized difference vegetation index is:

$$NDVI = \frac{NIR - R}{NIR + R}$$

where R and NIR are, respectively, the reflectance of the area of interest in the red (visible) and near-infrared bands. Said reflectance is extracted from the top-down image.

A general formula for the computation of the normalized difference water index is:

$$NDWI = \frac{G - NIR}{G + NIR}$$

where G is the reflectance of the area of interest in the green band.

In this case, the processing unit 6 is configured to associate each NDVI value and/or NDWI value with corresponding environmental data of the area of interest.

Advantageously, the processing unit 6 is configured to further determine, during the image analysis step 22, the environmental data based on the acquisition date of the top-down image. This is advantageous since the appearance of the primary producers (span, colour, etc.) and/or the biotope (reflectance, density, etc.) may vary over time, especially from season to season.

Advantageously, the processing unit 6 may also be configured to determine, during the image analysis step 22, the environmental data based on top-down images of the area of interest that have been acquired at different acquisition dates. This is advantageous, since the changes over time of a given image feature (such as NVDI and/or NWDI) may form a signature of a biotope or a primary producer.

Advantageously, the processing unit 6 may also be configured to determine, during the image analysis step 22, the environmental data based on the location of the area of interest. This feature is advantageous, as it allows to refine the determination of the environmental data, based on the location, by excluding primary producer or biotopes that are known to be absent from certain regions.

Alternatively, or in addition, the processing unit 6 is configured to implement an artificial intelligence model to analyse the top-down image in order to determine the corresponding environmental data. Such artificial intelligence model may have been previously trained to achieve such determination.

As an example, the artificial intelligence model has been previously trained based on NVDI and/or NWDI values in known areas where primary producers have been clearly identified, so as to learn which NVDI and/or NWDI values are associated with each primary producer.

Advantageously, the processing unit 6 is also configured to implement, during the image analysis step 22, at least one image analysis algorithm adapted to detect the presence of at least one predetermined human-made structure in the area of interest. Such human-made structures may include, in the case of marine and/or coastal environment, mooring buoys, fences, piers and the like.

Such feature is advantageous, as the presence of such human-made structures is likely to have a detrimental impact on the carbon capture potential of a given biotope.

### Carbon Capture Estimation Step 24

The processing unit 6 is also configured to compute, during the carbon capture estimation step 24, the carbon capture indicator that is representative of the estimated carbon capture potential of the area of interest, based on the determined environmental data.

Preferably, in the case where the determined environmental data include at least one biotope of the area of interest, the processing unit 6 is configured to determine the corresponding primary producers based on the primary producer data stored in the knowledge database 4.

Furthermore, the processing unit 6 is configured to associate each determined primary producer with a corresponding expected net primary productivity, based on the primary productivity data stored in the knowledge database 4. In this case, the computed carbon capture indicator is a net primary productivity of the area of interest.

Advantageously, in the case where the processing unit 6 has detected human-made structure in the area of interest, the processing unit 6 is also configured to compute the carbon capture indicator based on each detected human-made structure. This is advantageous because the presence of human-made structures can dramatically reduce the amount of primary producers in their vicinity, and therefore hinder the net primary productivity of the area of interest.

Preferably, the processing unit 6 is configured to further calculate the carbon capture potential of the area of interest based on the computed carbon capture indicator and on the carbon capture data.

For example, the processing unit 6 is configured to calculate the carbon capture potential of the area of interest based on a result of multiplying the computed net primary productivity with the total surface of the area of interest.

The processing unit 6 may be further configured to apply a coefficient to the result of the aforementioned multiplication in order to obtain the carbon capture potential.

Said coefficient advantageously depends on the on-site measurement data and/or the habitat data stored in the knowledge database 4.

This feature is advantageous, given that habitat topological and hydrological conditions, among other habitat data, may influence sedimentation rates and sediment transport, thereby affecting the carbon capture potential. On-site measurement data may allow to increase the accuracy of the applied coefficient.

Said coefficient may also depend on the actual surface occupied by each biotope and/or each primary producer in the area of interest.

### Forecasting Step 26

Preferably, the processing unit 6 is configured to estimate, during the forecasting step 26, an evolution of the carbon capture indicator and/or the carbon capture potential of the area of interest over time, based on the determined environmental data.

For instance, the processing unit 6 is configured to monitor an evolution over time of the carbon capture indicator and/or the carbon capture potential, and to extrapolate a corresponding future value based on said evolution.

In this case, the processing unit 6 is advantageously configured to further estimate the evolution of the carbon capture indicator over time based on each detected human-made structure.

### Monitoring Step 28

Preferably, the computed carbon capture indicator is associated with a date of acquisition of each corresponding top-down image.

In this case, the processing unit 6 is configured to monitor, during the monitoring step 28, an evolution of the carbon capture indicator over time, and to output an alert signal if a corresponding variation over time is outside a predetermined range.

Alternatively, or in addition, the processing unit 6 is configured to associate the determined environmental data with a date of acquisition of each corresponding top-down image. In this case, the processing unit 6 is further configured to monitor an evolution of the environmental data over time, and to output an alert signal if a corresponding variation over time is outside a predetermined range.

Moreover, in the case where the forecasting step 26 is performed, the processing unit 6 may be configured to output the alert signal if the variation over time of the environmental data and/or carbon capture indicator deviates from the corresponding forecast value(s).

### Influence Determination Step 30

Preferably, the processing unit 6 is also configured to perform the aforementioned image analysis step 22 for at least one neighbouring area adjacent to the area of interest.

In this case, the processing unit 6 is advantageously configured to compute, during the influence determination step 30, a carbon capture indicator representative of an estimated carbon capture potential of said neighbouring area, based on the determined environmental data of said neighbouring area, and also on the computed carbon capture indicator of the area of interest.

This feature is advantageous, as it allows to take into account the fact that areas of healthy growth of primary producers can be expected to expand into surrounding areas of similar habitat as a result of vegetative reproduction or seed dispersal.

Calculating the carbon capture potential of the area of interest based on each primary producer is advantageous, as it increases the reliability of the obtained result.

Computing the carbon capture indicator based on the habitat data is also advantageous, as it further increases the accuracy of the result.

Computing the carbon capture indicator based on the retrieved on-site measurement data also provides the advantage of an increased accuracy of the result.

Using the NDVI and/or the NDWI to determine the environmental data is advantageous, as NDVI and/or NDWI values may be associated with specific primary producers and/or biotopes, especially when the evolution of the NDVI and/or the NDWI values is taken into account.

Determining the environmental data based on a series of top-down images of the area of interest acquired at different acquisition dates is advantageous, since the changes over time of a given image feature (such as NVDI and/or NWDI) may form a signature of a biotope or a primary producer.

Computing the carbon capture indicator based on each detected human-made structure is advantageous, as the presence of such human-made structures is likely to have a detrimental impact on the carbon capture potential of a given biotope.

Predicting the evolution of the carbon capture indicator over time is advantageous, as it allows to establish boundaries defining situations that may be considered as normal.

Monitoring an evolution, over time, of the environmental data and/or the carbon capture indicator is advantageous, as it allows for an automated detection of situations that are deemed abnormal.

Computing the carbon capture indicator of a neighbouring area of a given area of interest based on the carbon capture indicator of said area of interest is advantageous, as it allows to take into account the impact of areas of healthy growth of primary producers, which may expand into surrounding areas of similar habitat as a result of vegetative reproduction or seed dispersal, thereby potentially increasing the carbon capture potential of said neighbouring area.

### Operation

Operation of the remote monitoring system 2 will now be described.

During a preliminary step, the top-down images are stored in the knowledge database 4.

The primary producer data, the primary productivity data, carbon capture data, the on-site measurement data, the habitat data may also be stored in the knowledge database 4.

Then, the user inputs instructions, through the user interface 8, indicative of the area of interest for which an assessment of the carbon capture is required.

Then, the processing unit 6 retrieves, from the knowledge database 4, at least one top-down image of at least part of the area of interest.

Then, during the image analysis step 22, the processing unit 6 implements at least one image analysis algorithm on each retrieved top-down image to determine the environmental data representative of at least one biotope and/or at least one primary producer of the area of interest.

Then, during the carbon capture estimation step 24, the processing unit 6 computes the carbon capture indicator representative of the estimated carbon capture potential of the area of interest, based on the determined environmental data.

Preferably, the processing unit 6 further calculates the carbon capture potential of the area of interest based on the computed carbon capture indicator.

During the optional forecasting step 26, the processing unit 6 estimates an evolution of the carbon capture indicator and/or the carbon capture potential of the area of interest over time, based on the determined environmental data.

Moreover, during the optional monitoring step 28, the processing unit 6 monitors an evolution of the determined environmental data and/or the carbon capture indicator, and outputs an alert signal if an associated variation over time is outside a predetermined range, or deviates from the corresponding forecast value(s).

Optionally, the processing unit 6 performs the aforementioned image analysis step 22 for at least one neighbouring area adjacent to the area of interest, and computes, during the influence determination step 30, a carbon capture indicator representative of an estimated carbon capture potential of the neighbouring area, based on the determined environmental data of said neighbouring area, and also on the computed carbon capture indicator of the area of interest.

Of course, the invention is not limited to the examples detailed above.

1. A computer-implemented method (20) for assessing carbon capture in an area of interest, the method comprising:
implementing (22) at least one image analysis algorithm on at least one top-down image of at least part of the area of interest, to determine environmental data representative of at least one primary producer and/or at least one biotope of the area of interest; and
based on the determined environmental data, computing (24) a carbon capture indicator representative of an estimated carbon capture potential of the area of interest.

2. The method (20) according to claim 1, wherein the computed carbon capture indicator is a net primary productivity of the area of interest.

3. The method (20) according to claim 2, further comprising calculating the carbon capture potential of the area of interest based on the net primary productivity and a size of the area of interest.

4. The method (20) according to claim 1, wherein the determined environmental data include at least one primary producer of the area of interest, and wherein computing the carbon capture indicator includes associating each primary producer to a corresponding expected net primary productivity.

5. The method (20) according to claim 1, wherein the carbon capture indicator is further computed based on habitat data associated with the area of interest and representative of climatic features, pedological features and/or sediment characteristics, geological features, hydrographic features and/or topographic features of the area of interest.

6. The method (20) according to claim 1, wherein the step (22) of implementing at least one image analysis algorithm includes computing, based on each top-down image, a normalized difference vegetation index and a normalized difference water index, the environmental data being determined based on the computed normalized difference vegetation index and normalized difference water index.

7. The method (20) according to claim 1, wherein the environmental data is further determined based on a series of top-down images of the area of interest acquired at different acquisition dates.

8. The method (20) according to claim 1, further including retrieving on-site measurement data representative of at least one physical and/or chemical property of the area of interest, the carbon capture indicator being further computed based on the retrieved on-site measurement data.

9. The method (20) according to claim 1, further including predicting (26) an evolution of the carbon capture indicator over time based on the determined environmental data.

10. The method (20) according to claim 1, wherein the step (22) of implementing at least one image analysis algorithm includes detecting the presence of at least one predetermined human-made structure in the area of interest, the carbon capture indicator being further computed based on each detected human-made structure.

11. The method (20) according to claim 10, further including predicting (26) an evolution of the carbon capture indicator over time based on the determined environmental data.

12. The method (20) according to claim 11, wherein the evolution of the carbon capture indicator over time is further predicted based on each detected human-made structure.

13. The method (20) according to claim 1, wherein at least one of the determined environmental data and the computed carbon capture indicator is associated with a date of acquisition of each corresponding top-down image, the method further including monitoring (28) an evolution of the environmental data and/or the carbon capture indicator over time, and outputting an alert signal if a corresponding variation over time is outside a predetermined range.

14. The method (20) according to claim 1, further comprising:
implementing at least one image analysis algorithm on at least one top-down image of at least one neighbouring area adjacent to the area of interest, to determine environmental data representative of at least one primary producer and/or at least one biotope of each neighbouring area; and
for each neighbouring area, computing (30) a carbon capture indicator representative of an estimated carbon capture potential of said neighbouring area, based on the determined environmental data of said neighbouring area and on the computed carbon capture indicator of the area of interest.

15. A computer program comprising instructions, which when executed by a computer, cause the computer to carry out the steps of the method of claim 1.

16. A remote monitoring system (2) for assessing carbon capture in an area of interest, the remote monitoring system (2) including a processing unit (6) configured to:
implement at least one image analysis algorithm on at least one top-down image of at least part of the area of interest, to determine environmental data representative of at least one primary producer and/or at least one biotope of the area of interest; and
based on the determined environmental data, compute a carbon capture indicator representative of an estimated carbon capture potential of the area of interest.
